(19) United States
(12) Patent Application Publication
(10) Pub. No.: US 2006/0204204 A1
(43) Pub. Date: Sep. 14, 2006

(54) Method for improving the optical polarization properties of a microlithographic projection exposure apparatus

(76) Inventors: Markus Zenzinger, Ulm (DE); Damian Fiolka, Oberkochen (DE)

Correspondence Address: FACTOR & LAKE, LTD, 1327 W. WASHINGTON BLVD., SUITE 5G/H, CHICAGO, IL, 60607, US

(21) Appl. No.: 11/311,513

(22) Filed: Dec. 19, 2005

Related U.S. Application Data
(60) Provisional application No. 60/637,490, filed on Dec. 20, 2004.

(51) Int. Cl. G02B 6/00

(52) U.S. Cl. 385/147

(57) ABSTRACT

An apparatus and method for improving the optical polarisation properties of a microlithographic projection exposure apparatus is disclosed. The method including a first step of providing a mounted optical system of the projection exposure apparatus, which contains a plurality of optical elements; a second step identifying those optical elements that perturb the optical polarisation properties in the mounted optical system to an extent that exceeds a limit value predetermined for the respective optical element; and, a third step implementing measures to improve the optical polarisation properties, which relate to the optical elements identified in the second step.

### CROSS-REFERENCE TO RELATED APPLICATIONS

This application claims benefit of provisional application Ser. No. 60/637,490 filed Dec. 20, 2004. The full disclosure of this earlier application is incorporated herein by reference.

### BACKGROUND OF THE INVENTION

1. Field of the Invention

The invention relates to a method for improving the optical polarization properties of a microlithographic projection exposure apparatus, by which structures contained in a mask can be imaged onto a photosensitive layer. The invention also relates to an optical system of such a microlithographic projection exposure apparatus, which is suitable for carrying out the method.

2. Description of Related Art

For the production of integrated electrical circuits and other microstructured components, a plurality of structured layers are applied on to a suitable substrate which, for example, may be a silicon wafer. In order to structure the layers, they are first covered with a photoresist which is sensitive to light of a particular wavelength range, for example light in the deep ultraviolet (DUV) spectral range. The wafer coated in this way is subsequently exposed in a projection exposure apparatus. A pattern of structures, which is placed on a mask, is then illuminated by an illumination system and imaged onto the photoresist by a projection objective. Since the imaging scale is generally less than 1, such projection objectives are often also referred to as reduction objectives.

After the photoresist has been developed, the wafer is subjected to an etching or deposition process so that the top layer becomes structured according to the pattern on the mask. The remaining photoresist is then removed from the other parts of the layer. This process is repeated until all the layers have been applied on the wafer.

One of the essential aims in the development of microlithographic projection exposure apparatus is to be able to generate structures with smaller and smaller dimensions on the wafer, so as to increase the integration density of the components to be produced. By using a wide variety of measures, it is now even possible to generate structures on the wafer whose dimensions are less than the wavelength of the projection light being used.

Particular importance is in this case attached to the polarization state of the projection light. This is related to the fact that in projection objectives, and specifically in those with particularly high numerical apertures, the polarization state has a direct effect on the contrast which can be achieved and therefore the minimum size of the structures to be generated.

For this reason, attempts are made to configure the most important optical subsystems of the projection exposure apparatus, i.e. the illumination system and the projection objective, so that they do not undesirably change a polarization state once it has been set.

Undesirable changes in the polarization state are often caused by the birefringence of materials which are used to produce the lenses and other optical elements. The term birefringent refers to materials whose refractive index is anisotropic. The effect of this anisotropy is that the refractive index for a transmitted light ray depends on the direction and polarization state of the light ray. When it passes through a birefringent material, unpolarized light is in general thereby split into two rays with mutually orthogonal polarization.

The birefringence of optical materials may be caused by various factors. For example, crystals may have crystal structures that are distinguished by particular symmetry properties, which have an effect on the optical properties. Examples of this are uniaxial crystals, for example MgF₂. Even cubic crystalline crystals such as calcium fluoride (CaF₂) may also be birefringent despite their high symmetry—at least at very short wavelengths; these cases are usually referred to as intrinsic birefringence. Furthermore, non-crystalline materials may also be optically birefringent. In these cases, the birefringence is due to perturbations of the short-range atomic order, which may for example be caused by externally acting mechanical forces. Often, the material loses its birefringent property again when the causes of the short-range order perturbations cease. For example, if a lens frame exerts mechanical forces on a lens body held in it, where they lead to stress-induced birefringence, then this birefringence is in general fully or at least predominantly eliminated as soon as the lens frame is removed again.

If the stresses caused by external forces remain in the material, then this can lead to irreversible stress-induced birefringence. Quartz glass preforms, such as those used for the production of lenses and other refractively acting optical elements, are an example of this. The magnitude and orientation of the birefringence in these cases depend on the production method according to which the preform is manufactured. Often, a production method is selected in which the magnitude and orientation of the birefringence have an at least approximately axisymmetric profile with respect to a symmetry axis of the preform. The magnitude of the birefringence then in general increases approximately quadratically as the distance from the symmetry axis of the preform becomes greater.

Besides birefringent optical elements, mirrors used for folding the beam path or for imaging purposes may also change the polarization state of the projection light in an undesirable way. This is related to the fact that the reflectivity of the mirrors generally depends on the polarization state of the incident projection light. For example, if linearly polarized light which contains both an s-polarized component and a p-polarized component strikes a mirror, then the different reflectivity for the two components effectively leads to a rotation of the polarization direction.

In order to reduce the aforementioned causes of perturbations of the polarization state, the procedure adopted so far has been to analyse the individual optical elements separately with respect to optical polarization before assembly. This can in fact determine perturbation contributions which cannot be inferred directly from the crystal structure. In the case of the birefringence which occurs in lens preforms owing to material stresses during the production process, however, the birefringence distribution can in general be predicted only approximately unless measurements are carried out.

If it is found during the optical polarization analysis that some optical elements make intolerably large perturbation contributions, then they may for example be replaced by equivalent optical elements which perturb the polarization state of the transmitted polarization light less strongly.

Even if the individual optical elements are analysed with respect to optical polarization before assembly, it has nevertheless been found that the overall optical system may sometimes not comply with the requisite specifications concerning optical polarization properties.

### SUMMARY OF THE INVENTION

It is therefore an object of the invention to provide a method for improving the optical polarization properties of a microlithographic projection exposure apparatus.

This object is achieved by a method having the following steps:
a) providing a mounted optical system of the projection exposure apparatus, which contains a plurality of optical elements;
b) identifying those optical elements which perturb the optical polarization properties in the mounted optical system to an extent which exceeds a limit value predetermined for the respective optical element;
c) implementing measures which relate to the optical elements identified in step b), in order to improve the optical polarization properties.

Since identification of the optical polarization properties of intolerably perturbing optical elements is carried out in the optical system once it has finally been mounted, it is also possible to detect those perturbations which do not occur until the optical system is mounted. These perturbations include, in particular, the stress-induced birefringence which is caused by lens frames. Although in principle it is possible for lenses provided with frames to be analysed with respect to optical polarization before installation in the optical system, nevertheless the birefringence distribution resulting from this is generally only provisional. This is related to the fact that additional forces, the size and direction of which are unpredictable, may be exerted on the lenses during installation of the lens frames in the optical system and subsequent adjustment. Only analysis of the optical polarization properties inside the mounted optical system can therefore give accurate information about those perturbations of the optical polarization properties which do not occur until mounting and subsequent adjustment of the lenses.

The same applies to the case in which the optical element is a mirror. Here again, mounting and adjustment of the mirror holder may lead to material stresses which can slightly change the polarization dependency of the mirror coating.

Which perturbations of the polarization state are intolerable for a particular optical element depends on the configuration of the optical system and the requirements which are placed on the optical polarization properties. Since thick lenses generate greater phase retardations due to birefringence, owing to the longer optical path, it may be expedient for limit values which can still be tolerated for the perturbations of the polarization state to be established individually for the separate optical elements of the optical system. For a thick lens, for example, the limit value would then be higher than for a thin lens. On the other hand, it may be expedient to carry out the measures according to step c) only for those optical elements which, in absolute terms, make the greatest contribution to the perturbation of the polarization state. From such a standpoint, it may therefore be more favourable to make the limit value equally high for all the optical elements.

It should be understood that the term “limit value” need not necessarily be an individual numerical value in this case, for example a mean value averaged over the optically active surface of the optical element. Instead, a limit value in this context may also be formed by a set consisting of a plurality of individual values, the individual values characterising different optical polarization quantities. Such a set may, for example, be the maximum value of the phase retardation due to birefringence which occurs over the optically active surface of the optical element, or a mean value over all the phased retardations which occur.

If it is found in step b) that an optical element perturbs the optical polarization properties intolerably, then various measures may be envisaged according to step c). One of these measures in step c) may consist in replacing the optical elements identified beforehand in step b). The newly installed optical element may then, for example, have a permanent stress-induced birefringence which is less than that of the previously extracted optical element.

Another measure may consist in extracting the relevant optical element and re-installing it in a different orientation. This is because re-mounting and adjusting the new optical element may lead to forces which cause a lower stress-induced birefringence overall.

A further measure which may be carried out in step c) as an alternative, and optionally in addition, consists in exerting mechanical forces on the optical elements identified in step b). When their magnitude and direction are selected suitably, such mechanical forces can offer at least partial compensation for the stress-induced birefringence.

In this case, for example, it is feasible to impart mechanical oscillations to the optical element identified in step b), as is known per se in the prior art. Actuators, for example piezo-elements, distributed circumferentially on the at least one optical elements may be used for this purpose.

In principle, the identification of the optical elements according to step b) inside the mounted optical system may be carried out by introducing a light source, which generates linearly polarized light, into the beam path in front of the individual optical elements. An optical polarization measuring device, which is used to analyse the optical polarization properties of the optical element, should then be introduced into the beam path behind the respective optical element. However, such a procedure is relatively elaborate and sometimes may even be impracticable for many optical elements, since there is often no space inside the optical element to introduce additional light sources or measuring devices.

For this reason, the identification in step b) is preferably carried out according to a method having the following steps:
i) inserting a first polarizer, which polarizes transmitted light linearly in a first polarization direction, into the beam path of the optical system at a first insertion position in front of an optical element;
ii) inserting a second polarizer, which polarizes transmitted light linearly in a second polarization direction, into the beam path of the optical system at a second insertion position behind the optical element;
iii) measuring the intensity of light which has been transmitted through the entire optical system in an image plane of the optical system.

This method of identification according to step b) has the advantage that it is merely necessary to insert comparatively thin polarizers into the beam path, in order to be able to determine at least qualitatively the optical polarization properties of the optical element or elements which lie between the two inserted polarizers.

The light source used may be the light source which is already present in the illumination system of the projection exposure apparatus.

The measuring system which analyses the intensity in step iii) is arranged outside, i.e. in the image plane of the optical system, so that this does not entail any problems of installation space. In this way, the method of identification according to step b) can be carried out even when the projection exposure apparatus has already been put into operation. If it is found that the imaging properties are deteriorating during operation, then according to steps i) to iii) it is possible to identify those optical elements which are contributing most to the deterioration of the optical polarization properties. Such deteriorations in the course of operation may, for example, be due to an effect which is referred to as polarization-induced birefringence. Energetic linearly polarized light can generate anisotropic density fluctuations in optical materials, which lead to birefringence. This effect is described, for example, in articles by N. F. Borelli et al. entitled “Excimer laser-induced expansion in hydrogen-loaded silica”, Appl. Phys. Lett., Vol. 78, No 17, Apr. 23, 2001, pages 2452 to 2454, and entitled “Polarized excimer laser-induced birefringence in silica”, Appl. Phys. Lett., Vol. 80, No 2, Jan. 14, 2002, pages 219 to 221.

The method according to the invention therefore makes it possible to locate optical elements, which intolerably perturb the polarization state, very straightforwardly in the optical system once it has finally been mounted, in order to optionally replace them or implement measures on them which reduce the birefringence. This can obviate time-consuming extraction and installation of all the optical elements, including the necessary adjustment work. This aspect is important, in particular, when an optical system of a microlithographic projection exposure apparatus is intended to be checked in the context of maintenance. The shorter the offline times are in this case, the lower the projection losses during the maintenance work will be.

When more insertion positions are provided in the optical system, the optical elements which intolerably compromise the optical polarization properties can be located with commensurately more accuracy. In the ideal case, there is an insertion position where a polarizer can be inserted immediately in front of and immediately behind each optical element from which significant perturbation of the optical polarization properties may be expected. If the optical system contains N optical elements, for example, then N+1 holders should be provided which need to be arranged between the optical elements so that exactly one optical element is arranged between two holders. In this way, it is possible to analyse each individual optical element at least qualitatively with respect to optical polarization in the finally mounted system.

If the optical element is a rotator which rotates the polarization direction through 90°, then the two polarizers in front of and behind the half-wave plate may be aligned so that the polarization direction is identical. If a non-zero intensity is then measured in the image plane in step iii), it can be concluded from this that the polarization rotation by the rotator is incomplete.

Apart from this special case, however, it will generally be more favourable for the two polarization directions of the polarizers to differ from each other, preferably by 90°. In this way, light can be measured in the image plane only if the optical element arranged between the two polarizers is birefringent and therefore leads to the creation of a polarization component which is polarized perpendicularly to the polarization direction of the first polarizer. In the case of an optical element which is free from birefringence, conversely, no light can penetrate through the crossed arrangement of the polarizers.

In the case of intrinsic birefringence, in order to prevent one of the optical birefringence axes from randomly being aligned along the polarization direction dictated by the first polarizer, steps i) to iii) may be repeated for the same insertion positions of the polarizers but with the two polarization directions being changed by a particular angle value, preferably 45°. If the first measurement has randomly placed the specified alignment of the polarization direction along one of the optical birefringence axes, then this random configuration will be precluded from the second measurement.

Moreover, repetition of the measurement with the polarization directions of the polarizers being changed may also be expedient in order to obtain not only a qualitative assessment but also quantitative information about the optical polarization properties of the optical element or elements respectively being analysed. For example, if the first polarizer is left unchanged and the measurements according to step iii) are carried out with different angular settings of the second polarizer, then the magnitude and direction of the birefringence of the element or elements being analysed can be deduced by algorithms which are known per se.

When an optical element which greatly perturbs the optical polarization properties has been identified according to step b), then the conduct of further measurements may sometimes be obviated if the measures carried out according to step c) on the identified optical element have already recovered an optical system which meets the optical polarization requirements. In general, however, it will be favourable to repeat steps i) to iii) with respectively different insertion positions until all the optical elements of the optical system have been arranged at least once between the two insertion positions used in a measurement according to step iii).

The polarizers, the polarization direction of which is preferably constant over the entire optically active surface, may for example be wire or film polarizers as known per se in the prior art. When the light source of the illumination system is used in the identification according to step b), however, it is necessary to make sure that the polarizer does actually have a polarizing effect on light of the relevant wavelength. Furthermore, the polarizer should have a structure which is as flat as possible so that it can be inserted into the beam path even between two optical elements which are placed very close together.

From this viewpoint, for example, polarizers with polarization-selective beam splitter layers or so-called grating polarizers are particularly suitable. The latter contain grating structures which respectively comprise a plurality of dielectric layers arranged above one another, parallel to a grating plane. Further examples of suitable polarizers can be found in the international application PCT/EP2004/008892 in the name of the Applicant, the disclosure of which is fully incorporated into the content of the present application.

If the intensity is measured as a function of the position in the image plane according to step iii), then the position dependency of the birefringence can be deduced even for those optical elements which are arranged in the vicinity of a field plane.

If, in addition or as an alternative, the intensity is measured as a function of the angle at which light strikes a selected position in the image plane, then it is possible to obtain information about the birefringence distribution of optical elements which are arranged in or close to a pupil plane of the optical system.

Since both the illumination system and the projection objective of a microlithographic projection exposure apparatus are generally filled with a protective gas, the holders into which the polarizers are inserted during the measurement according to step iii) should be sealable, in order to prevent ingress of ambient air into the relevant optical system.

### BRIEF DESCRIPTION OF THE DRAWINGS

Other features and advantages will be found in the following description of an exemplary embodiment with reference to the drawing, in which:

FIG. 1 shows a projection exposure apparatus in a schematized side view which is not true to scale;

FIG. 2 shows essential components of an illumination system of the projection exposure apparatus shown in FIG. 1 according to a first exemplary embodiment, in a simplified meridian section which is not true to scale;

FIG. 3 shows a detail of the illumination system shown in FIG. 2, in a simplified perspective representation;

FIGS. 4a and 4b show the polarization directions of the polarizers in two different measuring positions;

FIG. 5 shows a detail of an illumination system according to a second exemplary embodiment, in a simplified meridian section which is not true to scale.

### DESCRIPTION OF PREFERRED EMBODIMENTS

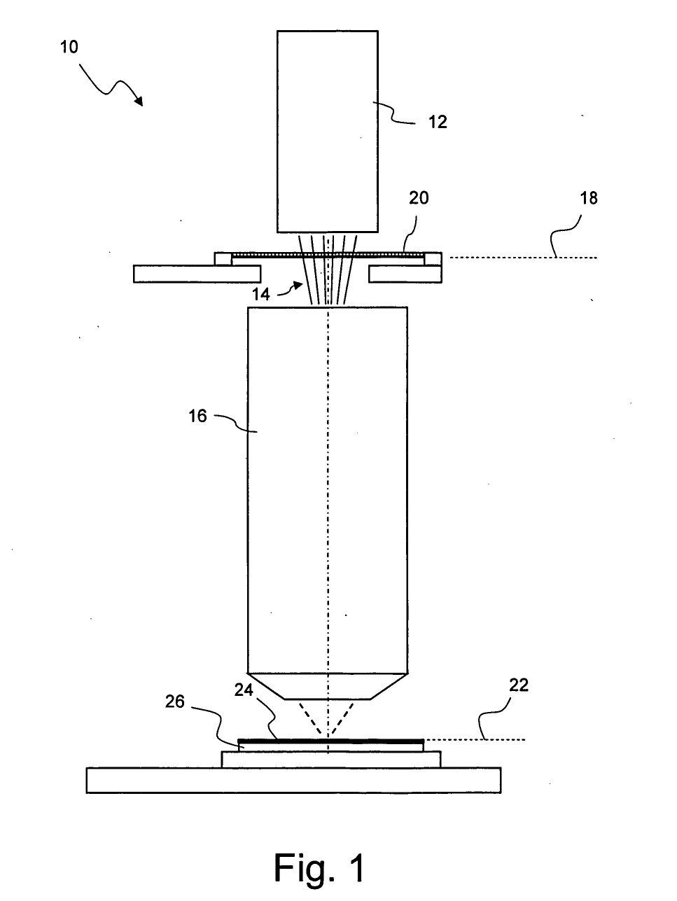

FIG. 1 shows a projection exposure apparatus, denoted overall by 10, in a simplified side view which is not true to scale. The projection exposure apparatus 10 comprises an illumination system 12, which is used to generate a projection light beam 14, and a projection objective 16, in the object plane 18 of which a mask 20 is arranged in such a way that it can be displaced. In an image plane 22 of the projection objective 16, there is a photosensitive layer 24 which is applied on a substrate 26, which may for example be a silicon wafer.

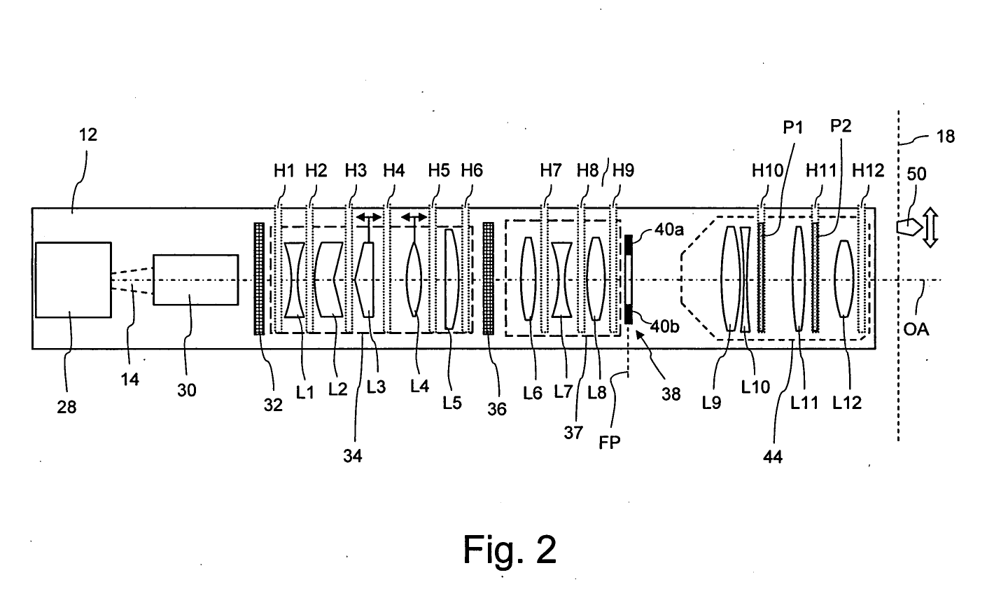

FIG. 2 shows details of the illumination system 12 in a schematic representation. The illumination system 12 contains a light source 28 which, in the exemplary embodiment shown here, is an excimer laser generating projection light with a wavelength of λ=193 nm. The projection light beam 14, which initially is still highly collimated, passes through a beam expansion unit 30, a first optical grid element 32, a zoom-axicon objective 34 with optical elements which are mobile in the axial direction in order to adjust different types of illumination, a second optical grid element 36, which is arranged in an exit pupil of the zoom-axicon objective 34, and input optics 37. A masking device 38, which can establish the geometry of a light field illuminating the mask 20, is arranged in or immediately next to a field plane FP on the exit side of the input optics 37. To this end, in the exemplary embodiment represented, the masking device 38 comprises two pairs of mutually opposing blades arranged perpendicularly to one another, of which only the blades denoted by 40a, 40b that extend perpendicularly to the plane of the paper can be seen in FIG. 2.

The illumination system 12 furthermore comprises a masking objective 44, whose object plane coincides with the field plane FP and whose image plane coincides with the object plane 18 of the projection objective 16. The blades 40a, 40b are thereby imaged sharply onto the mask 20 by the masking objective 44.

The zoom-axicon objective 34, the input optics 37 and the masking objective 44 respectively contain a multiplicity of individual lenses and other optical elements, which are merely indicated schematically and denoted by L1 to L12 in FIG. 2. A total of 12 holders H1 to H12 are distributed along the optical axis OA of the illumination system 12. The holders H1 to H12 are configured so that polarization filters can be inserted into them as required in the finally mounted illumination system 12. The holders H1 to H12 are furthermore distributed along the optical axis OA so that one of the optical elements L1 to L12 is in each case arranged (or can be arranged, if optical elements such as the axicon element L3 and the lens L4 can be displaced along the optical axis OA) between two respectively adjacent holders Hk and Hk+1. Only between the lenses L9 and L10 is there no holder, since the distance between these two lenses L9, L10 forming a doublet is so small that a polarizer could not be inserted between them.

The optical elements L1 to L12 may, for example, be made of synthetic quartz glass or a crystalline fluoride, for example calcium fluoride. The choice of material depends crucially on the wavelength of the projection light which is generated by the light source 28. For the wavelength of 193 nm selected here, synthetic quartz glass still has a high transmissivity so that the use of fluoride crystals may be obviated or restricted to a few optical elements, for example particularly thick lenses. In the case of light sources which generate shorter-wave projection light, the transmissivity of quartz glass is so low that all the optical elements should be made of fluoride crystals.

Fluoride crystals are intrinsically birefringent at very short wavelengths. The birefringence distribution is in this case dictated by the orientation of the crystal lattice relative to the optical axis OA. If quartz glass is used as the material for the optical elements L1 to L12, then the quartz glass preforms used for the lens production are also often irreversibly birefringent. This birefringence is caused by material stresses which occur during production of the lens preforms. In contrast to intrinsic birefringence, stress-induced birefringence is in general at least approximately independent of angle and depends only on the position where a light ray passes through the preform. In such preforms, with particular production methods, a birefringence distribution is observed which is axisymmetric with respect to a symmetry axis of the preform. The magnitude of the birefringence then in general increases approximately quadratically as the distance from the symmetry axis of the preform becomes greater.

Whereas the intrinsic birefringence in fluoride crystals is dictated by the crystal orientation, the stress-induced birefringence in quartz glass can only be determined with the aid of optical polarization measurements. Only those preforms whose irreversible stress-induced birefringence does not exceed a limit value established for the relevant element are then suitable for use in the illumination system.

The optical elements L1 to L12 made from the preforms are provided with frames before installation in the illumination system 12. Optionally, it is now possible to carry out another measurement of the optical polarization properties before installation. Such a measurement may be necessary if the holders exert forces, which cause material stresses, on the optical elements L1 to L12. These material stresses may lead to a stress-induced birefringence, usually reversible, which in general has a complicated and not readily predictable profile over the surface of the optical element. If it is found in such a further optical polarization measurement that certain optical elements no longer fulfil the requisite optical polarization specifications owing to this extra reversible component of stress-induced birefringence, then attempts may be made to change the frames of the relevant optical elements or, by deliberately inducing additional forces, to produce an at least axisymmetric birefringence distribution which can sometimes be compensated for.

The optical elements L1 to L12 optionally checked in this way are then installed with their frames in the illumination system 12, and are adjusted. The installation and adjustment, however, may cause additional forces to act on the optical elements L1 to L12 and generate a (further) contribution to stress-induced birefringence. This component may be so large that the optical polarization properties of the overall illumination system 12 are intolerably degraded.

In order to find this out, the entire finally mounted and adjusted illumination system 12 is firstly analysed with respect to optical polarization. This may be done, for example, by using a measuring device arranged in the plane 18 to measure the polarization state of the incoming light as a function of the field position. Since the light source 28 is generally in the form of a laser, the projection light 14 passing through the optical elements L1 to L12 is initially polarized linearly to a high degree. If the optical elements L1 to L12 as a whole are not birefringent, or at least not significantly birefringent, then this linear polarization state will be preserved. The polarization state will be perturbed if this condition is not satisfied, however, and this can be detected by the measuring device.

If, during this optical polarization analysis of the mounted illumination system 12, it is found that the polarization state is perturbed intolerably by the optical elements L1 to L12, even though they corresponded to the respective optical polarization specifications before they were installed and adjusted, then the likely cause of perturbation is essentially only a reversible component of the birefringence, attributable to forces which were created during installation of the holders in a housing of the illumination system 12 and the subsequent adjustment.

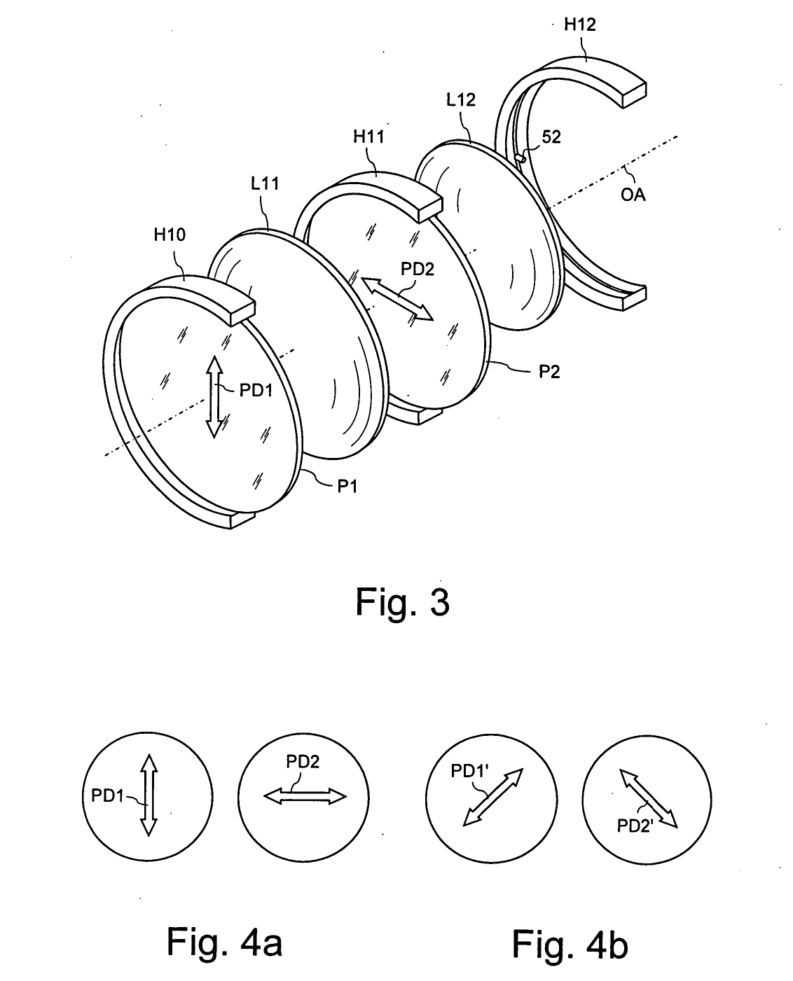

A method by which it is possible for the optical polarization properties of individual elements, or fairly small groups of neighbouring optical elements, to be analysed with respect to optical polarization in the finally mounted and adjusted illumination system 12, will be explained below with reference to FIGS. 3 and 4a, 4b.

To this end, two polarizers P1, P2 are firstly inserted into two mutually adjacent holders Hk, Hk+1. It is in principle not important which pair of adjacent holders is selected first. If it is suspected that the observed perturbation of the polarization state can only be caused by a few optical elements, then it is expedient to begin with these optical elements. Owing to their own heavy weight, in particular, thick lenses with a large diameters often cause sizeable components of the stress-induced reversible birefringence, which are attributable to forces created during installation and adjustment of these lenses.

In the exemplary embodiment shown in FIGS. 2 to 4, it is assumed that the lens 11 contained in the masking objective 44 is intended to be analysed first with respect to optical polarization. To this end, the polarizers P1, P2 are inserted into the holders H10 and H11 respectively arranged immediately in front of and behind the lens L11.

FIG. 3 shows a simplified detail of the masking objective 44, in which the lenses L11 and L12, the holders H10, H11 and H12 and the polarizers P1 and P2 are shown in a perspective representation. If circular polarizers P1 and P2 are used, as in the exemplary embodiment represented, then it may be favourable to provide means in the holders which ensure that the inserted polarizers P1, P2 have exactly defined angular settings. Such means may, for example, be formed by recesses which are made on the circumferential surfaces of the polarizers P1, P2 and which interact with spring-loaded engaging lugs which are formed in the holders H1 to H12. In FIG. 3, such an engagement lug is indicated by 52 on the holder H12.

In FIG. 3, double arrows indicate polarization directions PD1, PD2 which the polarizers P1 and P2 respectively transmit. These directions are represented next to each other in a diagrammatic representation in FIG. 4a. If projection light generated by the light source 28 passes through the polarizer P1, then only the polarization component whose oscillation direction coincides with the polarization direction PD1 can cross the polarizer P1. Light which has crossed the polarizer P1 and then strikes the lens L11 is therefore polarized linearly in the polarization direction PD1 over the entire beam cross section. If the lens L11 is free from birefringence, then this linear polarization state will not be changed. Since the two polarization directions PD1, PD2 are arranged mutually perpendicularly, no light can cross the second polarizer P2 in this case. The polarizer P2 therefore acts like an analyser in conventional optical polarization measuring devices. A measuring head 50, which detects the intensity in the plane 18, does not therefore deliver an output signal.

If the lens L11 is birefringent, however, then a polarization component which has an—albeit comparatively small—component whose oscillation direction is parallel to the polarization direction PD2 will be split off from the linearly polarized light. This component can therefore cross the polarizer P2 and be detected by the measuring head 50. The occurrence of a non-zero measurement signal is therefore an indication that the lens L11 is birefringent.

In order to be able to determine quantitatively how great the birefringence in the lens L11 is, besides this purely qualitative information, the relative setting of the two polarization directions PD1, PD2 may be changed. Since in general the light source 28 generates linearly polarized light, the polarization direction PD1 should as far as possible be aligned so that as much light as possible can cross the first polarizer P1. The setting which corresponds to this can be determined by firstly removing the second polarizer P2 and carrying out a measurement of the intensity in the plane 18 with the aid of the measuring head 50 in different angular positions of the first polarizer P1. The second polarizer P2 is then inserted into the holder H11, for example with the perpendicular orientation, as shown in FIG. 4a, of the polarization direction PD2 relative to the polarization direction PD1 of the first polarizer P1. After an intensity measurement has been carried out in the plane 18 with the aid of the measuring head 50, the polarizer P2 is then rotated through a particular angle value about the optical axis OA, for example through 5°. The intensity in the plane 18 is then measured again, and the second polarizer P2 is rotated through a further 5°, and so on. With the aid of algorithms which are known per se, the birefringence distribution in the lens L11 can be deduced from the intensity distributions in the plane 18 which have been obtained in this way.

If the lens L11 is intrinsically birefringent, then the case could arise that the slow or fast birefringence axis is randomly aligned parallel to the polarization direction PD1 of the first polarizer P1. In this case, the birefringence of the lens L11 would remain unnoticed since splitting into sub-rays, mutually polarized orthogonally, would not take place. In order to avoid the mistaken conclusion that certain optical elements are not birefringent, owing to such an unfavourable configuration, both for a qualitative measurement (only one relative setting of the polarization directions PD1, PD2) and for a qualitative measurement (a plurality of such relative settings) it is necessary to ensure that at least two independent intensity measurements are carried out with different angular settings of the first polarizer P1.

FIG. 4b shows an example in which, after a first measurement with polarization directions as shown in FIG. 4a, a second measurement is carried out with the polarization directions PD1′ and PD2′ being orthogonal as before but rotated through 45° relative to the orientations in the first measurement. If the slow or fast birefringence axis was randomly aligned along the first polarization direction PD1 in the first measurement, then this would no longer be the case in the second measurement.

If the lens L11 lies in the vicinity of a field plane, then the intensity distribution measured in the plane 18 can be regarded as a spatial distribution of the birefringence over the surface of the lens L11. If such a relationship is also desirable for those optical elements which lie in the vicinity of a pupil plane, then it is necessary to carry out the intensity measurement with angle resolution in the field plane 18. This is related to the fact that angles in the field plane 18 are correlated with positions in the pupil plane, and vice versa. If the intensity is recorded with angle resolution during a measurement in the field plane 18, then optical elements near the pupil can therefore be associated with positions where the birefringence is so great that they lead to a detectable signal in the field plane 18 when the polarizers P1, P2 are in a crossed setting.

It should be understood that instead of polarizers P1, P2 which can be latched in different angle positions in the holders H1 to H12, it is also possible to use polarizers which can merely be inserted into a single position in the holders H1 to H12. Then, for example, the polarizers P1, P2 and the holders H1 to H12 may have a rectangular shape. If the intention is to obtain different polarization directions PD1, PD2, however, it is then necessary to provide a plurality of polarizers which differ from one another by the orientation of the polarization direction with respect to the rigidly determined insertion setting.

The specifications with which the optical elements L1 to L12 are meant to comply may be adjusted specifically for individual optical elements L1 to L12, or they may be common to all the optical elements L1 to L12. In general, the specifications comprise one or more limit values which relate to particular optical polarization properties. In a purely qualitative analysis, for example, it is conceivable that the intensity of the light recorded by the measuring head 50 should not exceed a predetermined first limit value anywhere in the field plane 18 and that the integrated intensity recorded over the entire illuminable surface in the field plane 18 should not exceed a second predetermined limit value.

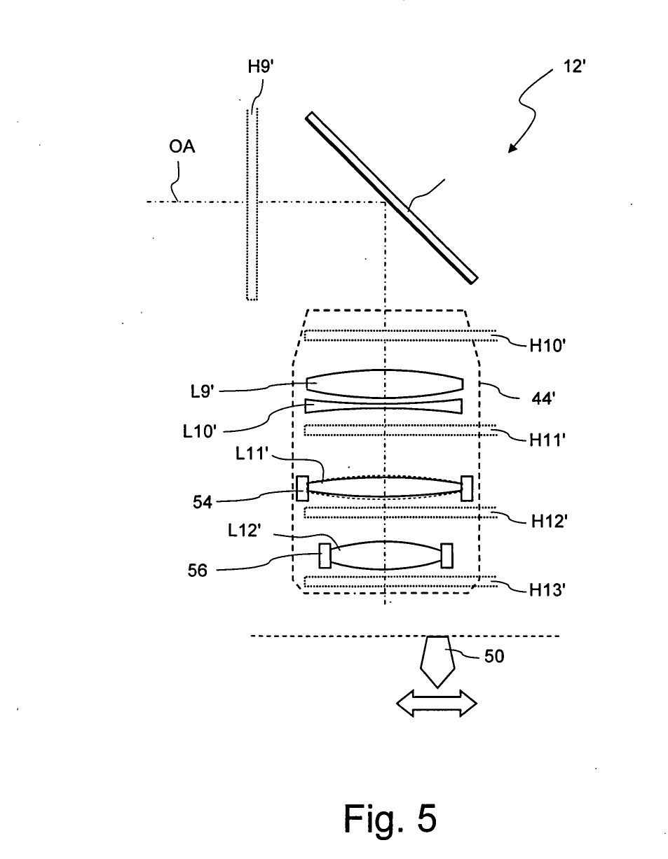

If it is found in the measurement that the lens L11 exceeds the limit value or values, then it is for example conceivable to extract the lens L11 and re-mount it in the frame. If the lens L11 consists of quartz glass, then it is also feasible for a new lens L11 to be produced from a preform whose stress-induced birefringence due to production is less. Another way of improving the optical polarization properties will be explained below with reference to FIG. 5.

If such measures are expected to make the illumination system 12 now fulfil the requisite specifications concerning the optical polarization properties, then these may be measured again without inserted polarizers P1, P2 after installation and re-adjustment of the lens L11. If there are no grounds for such an expectation, then the measurement described above will be repeated for another optical element of the illumination system 12. To this end, the polarizers P1, P2 are removed from their holders H10 and H11 and inserted into another pair of adjacent holders, for example the holders H1, H12. Owing to the large number of holders provided for the polarizers P1 and P2 it is possible to analyse all the optical elements L1 to L12 individually in the mounted state of the illumination system 12. Merely the lens doublet L9, L10 can be analysed only as a unit.

In order to prevent the protective gas contained in the housing of the illumination system 12 from escaping through the holders H1 to H12, the latter may be provided with gas-tight seals. The seals should be opened only if a polarizer needs to be inserted into a holder.

FIG. 5 shows a detail of an illumination system 12′ according to a second exemplary embodiment. The illumination system 12′ contains a plane deviating mirror 53, which folds the beam path through 90°. The deviating mirror 53 represents another optical element whose optical polarization properties can be analysed with the aid of two polarizers in the manner described above. To this end, holders H9′, H10′ for polarizers are arranged immediately in front of and behind the mirror 53.

For the optical elements L11′, L12′ in the illumination system 12′, piezo-actuators 54 and 56 distributed over the circumference of the lenses L11′, L12′ are provided. With the aid of the piezo-actuators 54, 56, radially acting forces can be generated in the lenses L11′, L12′. The material stresses resulting therefrom lead to additional birefringence components in the lenses L11′, L12′. If the analysis of the lenses L11′, L12′ shows that they do not correspond to the optical polarization specifications, then it is possible to reduce the birefringence of the lenses L11′, L12′, or at least make it axisymmetric, by exertion of radially acting compressive or tensile forces with the aid of the actuators 54 and 56. This is beneficial because an axisymmetric birefringence can generally be compensated for more easily by a perpendicularly oriented birefringence in other optical elements. The actuators 54, 56 may also be driven so that the induction of radially acting forces is synchronised with the generally pulse-operated light source 28. Further details of this can be found in US 2004/0150806 A1.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. A method for improving the optical polarisation properties of a microlithographic projection exposure apparatus comprising the steps of:
(a) providing a mounted optical system of the projection exposure apparatus, which contains a plurality of optical elements;
(b) identifying those optical elements that perturb the optical polarisation properties in the mounted optical system to an extent that exceeds a limit value predetermined for the respective optical element; and,
(c) implementing measures that relate to the optical elements identified in step (b), in order to improve the optical polarisation properties.

2. The method of claim 1, wherein the limit value is different for at least two optical elements.

3. The method of claim 1, wherein the limit value is a set of individual values for different optical polarisation quantities.

4. The method of claim 1, wherein the measures according to step (c) comprise replacement of the optical elements identified in step (b).

5. The method of claim 1, wherein the measures of step (c) comprise the exertion of mechanical forces on at least one of the optical elements identified in step (b).

6. The method of claim 5, wherein oscillations are imparted to at least one optical element among the optical elements identified in step (b).

7. The method of claim 6, wherein oscillations are imparted to at least one optical element by circumferentially distributed actuators.

8. The method of claim 1, wherein the identifying in step (b) comprises the following steps:
(i) inserting a first polarizer, which polarizes transmitted light linearly in a first polarizes transmitted light linearly in a first polarisation direction, into the beam path of the optical system at a first insertion position in front of an optical element;
(ii) inserting a second polarizer, which polarizes transmitted light linearly in a second polarisation direction, into the beam path of the optical system at a second insertion position behind the optical element; and,
(iii) measuring the intensity of light that has been transmitted through the entire optical system in an image plane of the optical system.

9. The method of claim 8, wherein the first insertion position is arranged immediately in front of the optical element.

10. The method of claim 8, wherein the second insertion position is arranged immediately behind the optical element.

11. The method of claim 8, wherein the first polarisation is different from the second polarisation direction.

12. The method of claim 11, wherein the first polarisation direction makes an angle of 90° with the second polarisation direction.

13. The method of claim 8, wherein steps (i) through (iii) are repeated for the same insertion positions, with only the first or second polarisation direction being changed.

14. The method of claim 8, wherein steps (i) through (iii) are repeated for the same insertion positions, with both the first polarisation direction and the second polarisation direction being changed.

15. The method of claim 14, wherein the change in the two polarisation directions includes rotating the polarisation directions through 45°.

16. The method of claim 8, wherein steps (i) through (iii) are repeated with respectively different insertion positions until all the optical elements of the optical system have been arranged at least once between the two insertion positions used in a measurement according to step (iii).

17. The method of claim 8, wherein the first polarisation direction is constant over the entire first polarizer.

18. Method according of claim 8, wherein the second polarisation direction is constant over the entire second polarizer.

19. The method of claim 8, wherein at least one polarizer is a wire polariser.

20. The method of claim 8, wherein at least one polariser is a grating polariser.

21. The method of claim 20, wherein the at least one polariser includes grating structures which respectively comprise a plurality of dielectric layers arranged above one another and parallel to a grating plane.

22. The method of claim 8, wherein at least one polariser includes a polarisation-selective beam splitter layer.

23. The method of claim 8, wherein the transmitted light has a wavelength that at least approximately coincides with an operating wavelength for which the optical system is a designed.

24. The method of claim 8, wherein the intensity is measured in step (iii) as a function of the position in the image.

25. The method of claim 8, wherein the intensity is measured in step (iii) as a function of the angle at which light impinges on a selected position in the image plane.

26. The method of claim 8, wherein holders for holding the polarisers are hermetically sealed after removing a polariser.

27. The method of claim 1, wherein the optical system is an illumination system of the microlithographic projection exposure apparatus.

28. The method of claim 1, wherein the optical system is a projection objective of the microlithographic projection exposure apparatus.

29. The method of claim 1, wherein the optical element is a lens or a mirror.

30. An optical system of a microlithographic projection exposure apparatus, the optical system comprising a plurality of holders for receiving a polariser, wherein between each adjacent pair of holders at least one optical element is arranged.

31. The optical system of claim 30, wherein at least three holders are distributed over the optical system so that each optical element of the optical system is arranged between two holders.

32. The optical system of claim 30, wherein exactly one optical element is arranged between two holders.

33. The optical system of claim 30, wherein at least N/2 holders are provided for N optical elements, with N being a positive integer greater than 1.

34. The optical system of claim 33, wherein N+1 holders are provided for N optical elements, and further wherein the N+1 holders and the N optical elements are arranged such that exactly one optical element is arranged between two holders.
